(19) United States
(12) Patent Application Publication
(10) Pub. No.: US 2009/0038687 A1
(43) Pub. Date: Feb. 12, 2009

(54) Thermally Activated Pressure Relief Valve

(75) Inventors: Paul Kremer, Walferdange (LU); Jacques Schmit, Eppeldorf (LU)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: LUXEMBOURG PATENT COMPANY S.A., Lintgen, LU (LU)

(21) Appl. No.: 11/816,141

(22) PCT Filed: Feb. 6, 2006
(86) PCT No.: PCT/EP2006/050676

§ 371 Date: Jun. 11, 2008

(30) Foreign Application Priority Data
Feb. 14, 2005 (EP) 05101093.2

(51) Int. Cl. F16K 17/14

(52) U.S. Cl. 137/74

(57) ABSTRACT

The thermally activated pressure relief valve (10) has a piston (14) normally retained in a closed position and being movable to an open position in case the valve (10) is exposed to an abnormally high temperature. An elastic slotted spring sleeve (20) is disposed within a sleeve (18) of fusible material. In a non-activated state the fusible sleeve (18) maintains the spring sleeve (20) in a radially compressed condition wherein it has a smaller inner diameter effective to retain the piston (14) in the closed position. When the fusible sleeve (18) melts the spring sleeve (20) radially expands to a larger diameter permitting movement of the piston to the open position wherein it is partly received in the spring sleeve (20).

The present invention relates to a thermally activated pressure relief valve, especially for a compressed or liquefied gas cylinder, or for use with a gas tap adapted to be mounted on a gas cylinder.

Such thermally activated pressure relief valves are known in the prior art and are usually provided with a piston movable in a housing body and retained by a plug of fusible material, such as an eutectic metal alloy, in a closed position. If the relief valve is exposed to an abnormally high temperature exceeding a predetermined value, for example in case of fire, the fusible material melts and is forced out of a housing body under the effect of the gas cylinder pressure acting on the piston to urge the valve piston to an open position, in which it places the interior of the gas cylinder into communication with an outlet opening to release the gas pressure from within the gas cylinder to the surrounding environment. Such relief valves must open quickly in a high temperature environment but flowage of the fusible material must be avoided under normal conditions to avoid undesired opening of the relief valve. In the prior art valve the plug of fusible material is loaded in compression by the gas pressure in the gas cylinder acting on the relief valve piston. The fusible material loaded in compression has the tendency to flow with time under the effect of this compressive pressure and may be forced out of the housing body which may result in an undesired movement of the relief valve piston to its open position permitting undesired discharge of gas from within the gas cylinder even if the relief valve is not exposed to said abnormally high temperature. To prevent this, several attempts have been made in the prior art to avoid the fusible material loaded in compression to be forced out of the housing body during normal operating conditions when the temperature of the environment is below the predetermined temperature. So, for example, in the U.S. Pat. Nos. 4,800,948, 4,744,382 and 4,744,383 intricate flow passages have been proposed to prevent extrusion of the plug of fusible material. In the German laid-open publication DE 196 00 312 a member of porous material is arranged between the plug of fusible material and a housing body outlet to prevent extrusion of the fusible material during normal operation when it is in its solid state but which permits the melted fusible material to pass therethrough under the effect of the compressive load applied to the melted material. Another type of a thermally activated relief valve is disclosed in EP patent application 0 766 028, which also uses a porous member to prevent extrusion of the fusible material during normal operation. This porous member permits passage of the melted fusible material therethrough due to the relief valve having been exposed to a temperature exceeding the predetermined temperature. Another attempt to prevent extrusion of the fusible material is disclosed in U.S. Pat. No. 6,367,500 in which there is provided a differential piston having opposing piston faces of different areas exposed to the gas pressure in the gas cylinder to thereby reduce the compressive load exerted on the plug of fusible material.

A further known thermally activated relieve valve is disclosed in the EP patent application no. 1 418 372. According to this EP patent application the fusible material is loaded by shear forces in response to the high pressure fluid acting on the relief valve piston, as the fusible material has a better resistance to shear loads than to compressive loads.

Notwithstanding the above prior art solutions, there is a need for an improved solution of the problem referred to, namely insuring quick opening of the relief valve in an overtemperature condition while preventing extrusion of the fusible material and undesired opening of the relief valve during normal operating conditions.

More particularly, the object of the invention is to provide a simple quickly responsive thermally activated pressure relief valve but which prevents undesired opening of the relief valve during normal operating conditions, and to provide a tap for a pressurized or liquefied gas cylinder having such a valve.

This object is achieved in accordance with the invention by the provision of a thermally activated pressure relief valve comprising a valve housing having a longitudinal bore, said housing further having a high pressure fluid inlet and at least one fluid outlet, a piston axially movable in the housing bore between a closed position wherein it tightly seals the fluid inlet from the fluid outlet, and an open position in which the inlet is in fluid communication with the outlet through the longitudinal bore, the piston being normally retained by a fusible means in the closed position and being movable by the pressurized fluid to the open position in case of exposure of the relief valve to an abnormally high temperature causing melting of the fusible means,

characterized in that the fusible means is a fusible sleeve disposed within said housing bore, and a slotted spring sleeve is disposed within said fusible sleeve and normally maintained by said fusible sleeve in a radially compressed condition wherein the slotted sleeve has a smaller inner diameter, said slotted sleeve being adapted to expand radially to a radially expanded condition of larger inner diameter when the relief valve is exposed to said abnormally high temperature causing melting of said fusible sleeve, said spring sleeve in said compressed condition thereof being effective to retain said piston in said closed position and said spring sleeve allowing movement of said piston to the open position in the expanded condition thereof, and that said housing has outlet means communicating with the housing bore at the location of the fusible sleeve to permit fused material of said fusible sleeve to flow out from within said housing bore through said outlet means.

In the preferred embodiment an abutment member consisting of a spherical member is normally positioned axially between the piston and the spring sleeve and held by the piston (by the fluid pressure applied thereto) in engagement with an end of the spring sleeve in its compressed condition to retain the piston in the closed position wherein it tightly engages the housing bore between the fluid inlet and the fluid outlet and is outside or externally of the spring sleeve and prevented by the abutment member to move into the spring sleeve. The spherical member is separate from a stem portion of the piston and has a maximum diameter which is slightly larger than the piston stem portion and the inner diameter of the spring sleeve in the compressed condition thereof but not larger than the inner diameter of the spring sleeve in the expanded condition thereof. In the activated state of the relief valve, namely after fusion of the fusible sleeve, the spring sleeve is in its radially expanded condition and the abutment member as well as the stem portion of the piston is received in the spring sleeve and the piston has moved axially from the closed position to the open position thereof, wherein the fluid inlet is in communication with the fluid outlet to permit discharge of the pressurized fluid to the environment surrounding the pressure relief valve. In another embodiment an abutment end portion is formed integrally in one piece with the piston stem portion. Preferably the fusible sleeve consists of an eutectic metal alloy and the spring sleeve is of metallic, spring steel material. The spring sleeve may be helically or axially slotted.

The advantage of the invention is that the load applied to the fusible sleeve in a direction tending to force the fusible material to flow in its solid state into the fused material outlet means is reduced thereby improving the resistance to undesired opening of the relief valve. In the relief valve of the invention the axial force applied by the pressurized fluid to the piston is not fully applied to the fusible sleeve. Indeed, the resultant of the force applied by the spherical member to the spring sleeve has an axial component of force which is effective to force the sleeve axially against a bottom surface of the housing bore and a radial component of force which tends to expand the spring sleeve. Only this radial component of force, together with the spring force of the sleeve, is applied to the fusible sleeve thereby reducing the tendency of the solid fusible sleeve to flow into the outlet means. To further resist flowage of the fusible sleeve the outlet means has a narrow, restricted flow area.

The invention will now be described in greater detail with reference to the drawings, wherein:

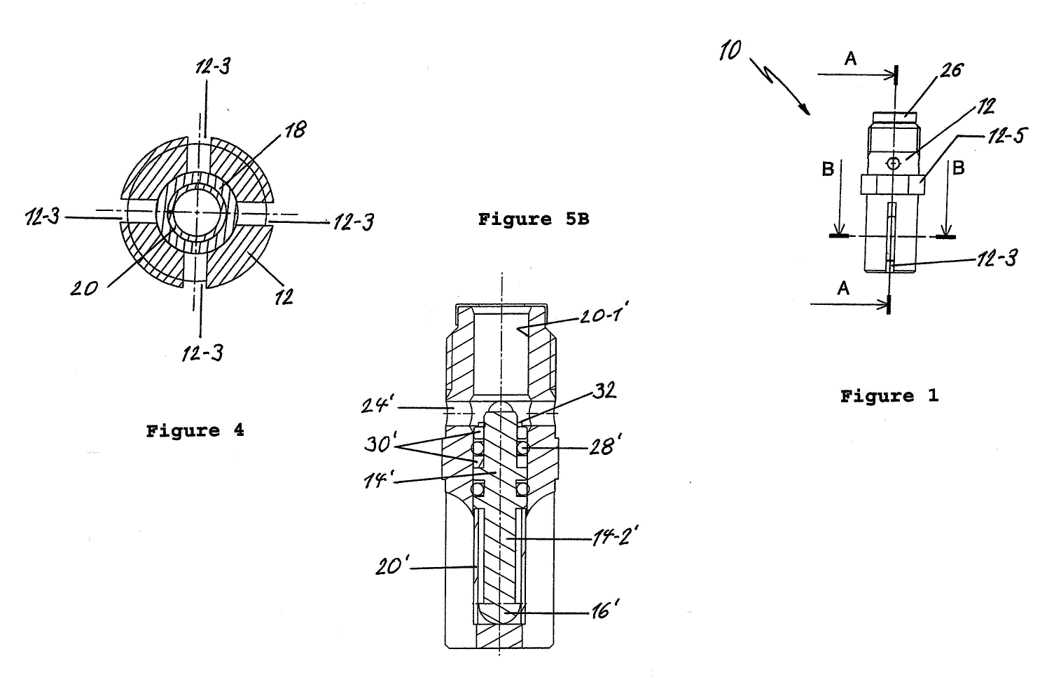

FIG. 1 is an elevational side view of the thermally activated pressure relief valve;

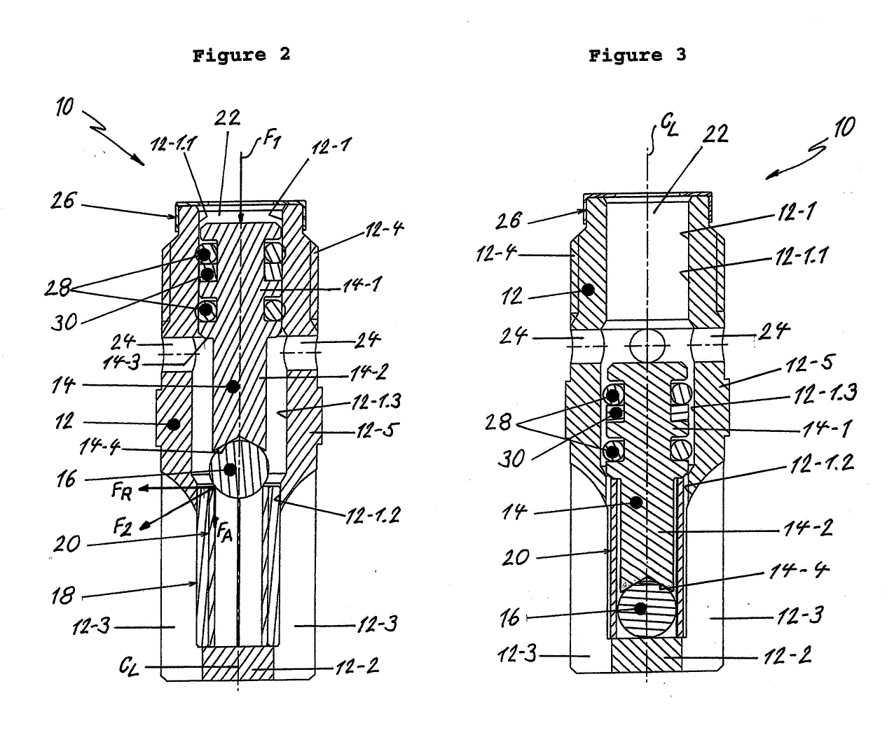

FIG. 2 is an enlarged view of the relief valve in longitudinal section taken along line A-A of FIG. 1 and in the non-activated condition;

FIG. 3 is a view similar to FIG. 2 but showing the thermally activated pressure relief valve in the activated condition;

FIG. 4 is a cross-sectional view in the direction of the arrows B-B in FIG. 1.

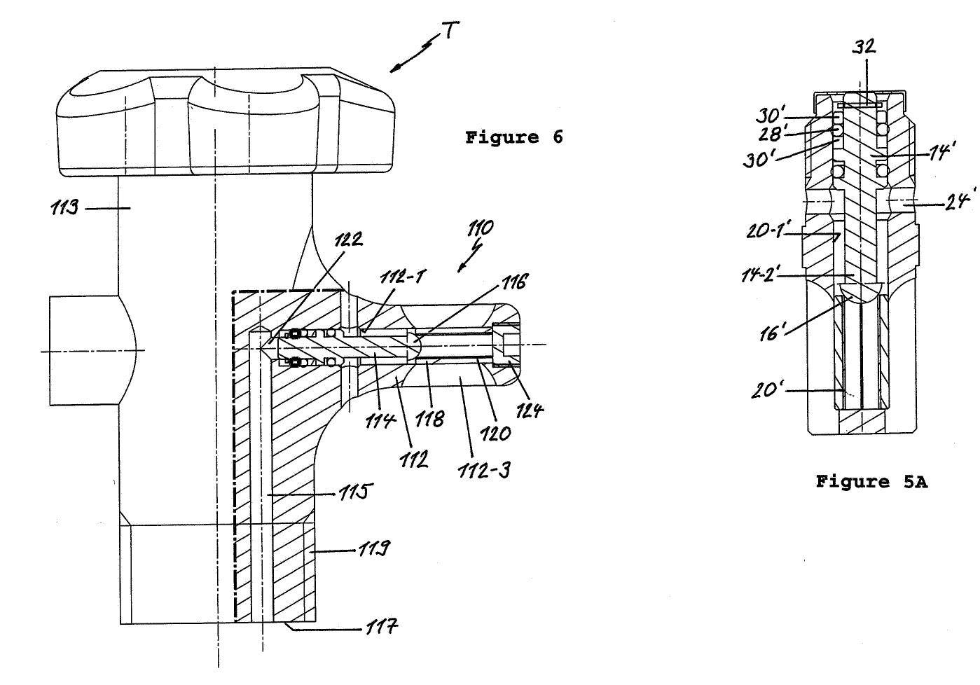

FIGS. 5A and 5B show another embodiment of the relief valve in a non-activated and an activated position, respectively; and

FIG. 6 shows a gas tap having an integral pressure relief valve as shown in FIGS. 5A and 5B.

Referring now in greater detail to the drawing FIGS. 1-4, wherein the thermally activated pressure relief valve is designated generally by reference numeral 10. The relief valve 10 consists essentially of a valve housing 12, a piston 14, an abutment member 16, a fusible sleeve 18 and an axially slotted spring sleeve 20.

The valve housing 12 is concentric about axial centerline C_{L} and has a longitudinal bore 12-1 coaxial with the centerline C_{L}. The longitudinal bore 12-1 has an upper and a lower portion of generally equal diameter 12-1.1 and 12-1.2 as well as an intermediate enlarged diameter portion 12-1.3. The longitudinal bore 12-1 opens out at the upper end of the valve housing 12, to define a high pressure fluid inlet 22. A plurality, for example four, circumferentially spaced, radially oriented fluid outlets 24 are formed through the wall of housing 12. The longitudinal bore 12-1 is closed at the end opposite the high pressure fluid inlet 22 by a housing end wall 12-2. The housing 12 has a plurality of circumferentially spaced axially extending slots 12-3 extending from the lower end surface of housing end wall 12-2 up to approximately the enlarged bore portion 12-1.3. The axially extending slots 12-3 have a relatively narrow width in circumferential direction for a purpose to be described later.

The housing 12 further has an external thread 12-4 in the upper portion thereof between the fluid outlets 24 and the upper end of the housing 12. Moreover, the outer surface of the housing 12 is provided with a polygonal, preferably hexagonal flange 12-5 to permit screwing of the relief valve by means of a wrench into a threaded opening of a valve body (not shown), preferably a gas tap body for a compressed or liquefied gas cylinder (not shown). When the pressure relief valve 10 is fixed to the tap body the fluid inlet 22 is in communication through a passage in the tap body with the interior of the gas cylinder. An annular sealing cap 26 is provided on the upper end of the valve housing 12 to permit a fluid tight engagement of the valve housing 12 with the gas tap body.

Disposed within the lower diameter portion 12-1.2 of the longitudinal bore 12-1 is the fusible sleeve 18. The fusible sleeve 18 has its outer circumferential surface in contact with the inner circumferential surface of the lower bore portion 12-1.2. The lower axial end of the fusible sleeve 18 engages the bottom surface or inner surface of housing end wall 12-1 and the upper axial end of the fusible sleeve 18 is generally located where the increased intermediate diameter portion 12-1.3 of the longitudinal bore 12-1 merges with the lower reduced diameter portion 12-1.2.

Disposed within the fusible material sleeve 18 is an axially slotted spring sleeve 20 of spring steel material. The spring sleeve 20 has generally the same length as the fusible sleeve 18 and is coextensive therewith and both sleeves 18, 20 are coaxial with housing centreline C_{L}. The spring sleeve 20 is maintained by the fusible sleeve 18 in a radially compressed condition. The spring sleeve 20, due to its spring force tends to enlarge radially outwardly and accordingly applies a radially outwardly directed load to the fusible sleeve 18.

From FIG. 2 it can be seen that the axial slots 12-3 of the valve housing 12 extend generally along the full length of the sleeves 18 and 20 from the lower end thereof but terminate adjacent the upper ends of the two sleeves.

Disposed within the longitudinal bore 12-1 coaxially with centreline C_{L} is also the piston 14 which has an upper head portion 14-1 and a lower stem portion 14-2 forming a radial shoulder surface 14-3 between the head and stem portions. The piston head portion 14-1 has in its outer circumferential surface two annular grooves, each having an O-ring 28 disposed therein. In the upper annular groove there is furthermore disposed a back-up ring 30 for supporting the seal ring 28. In the non-activated position of the pressure relief valve 10, shown in FIG. 2, the head portion 14-1 of the piston 14 is fluid tightly received in the upper reduced diameter portion 12-1.1 of longitudinal bore 12-1 to fluid tightly seal the high pressure fluid inlet 22 from the fluid outlets 24.

The piston 14 is normally retained in this non-activated condition by an abutment member 16 which has a larger maximum outer diameter than the internal diameter of the spring sleeve 20 in the radially compressed condition thereof. The piston stem portion 14-2 has at its lower end a V-shaped cut-out or recess 14-4 engaging the abutment member 16. The V-shaped cut-out has an obtuse downwardly opening angle defining a conical surface for engaging the abutment member 16 to serve as a seat therefor.

The abutment member 16 consists preferably of a spherical or ball-shaped member 16 but, generally, the abutment member 16 may have any appropriate shape having an abutment surface that decreases in diameter from the maximum outer diameter in the direction of its axial extension along the centreline C_{L} towards the housing bottom wall 12-2. For example, instead of being spherical, the abutment surface may have any other appropriate shape such as tapered, conical or curved for engagement with the upper end of the spring sleeve 20 to apply a force thereto tending to expand the spring sleeve 20 radially outwardly under the fluid pressure force applied to the piston 14 thereby assisting the spring force of the sleeve 20 to cause radial expansion thereof. If the abutment member 16 is not spherical it may have an integral pin extension (not shown) received and guided in an axial bore (not shown) of the piston 14, or the pin extension may be on the piston and received in a bore of the abutment member.

In the non-activated condition, when the upper surface of piston head portion 14-1 is exposed to a pressurized fluid, a downwardly directed force F₁ is applied to the piston 14 urging the spherical member 16 into engagement with the upper edge of the spring sleeve 20 and forcing the spring sleeve 20 downwardly against the bottom wall 12-2 of the housing 12. This causes in turn, the application of a downwardly and outwardly directed force F₂ to be applied by spherical member 16 to the spring sleeve 20. The force F₂ can be resolved into an axial component of force F_{A} and a radial component of force F_{R}. Only the radial component of force F_{R} of the resultant force F₂ applies an outwardly directed force or load on the fusible sleeve 18. The force F_{R} caused by the fluid pressure acts in conjunction with the spring force of slotted sleeve 20 tending to enlarge the sleeve 20. The spring force and the fluid pressure force F_{R} are lower than the application of a load on the fusible material corresponding to the full axial force F₁ applied to the piston 14.

The combined radially outwardly directed load applied to the fusible sleeve 18 tends to cause flowage of the fusible sleeve into the axial slots 12-3 in the non-activated condition of FIG. 2. To prevent this the axially extending slots 12-3 have a relative narrow width in circumferential direction to resist flowage of the fusible sleeve 18 into the slots 12-3 in the solid, non-fused condition of the sleeve 18. Instead of the slots 12-3 the housing wall portion surrounding the fusible material 18 may also be formed partially or totally of porous material.

Referring now particularly to FIGS. 2 and 3 showing the non-activated and the activated condition, respectively, of the pressure relief valve 10 of the invention, it can be noted that in the non-activated condition of FIG. 2, spring sleeve 20 acts as a stop means against which the spherical member 16 abuts. Accordingly, the spherical member 16 cannot move into the spring sleeve 20 thereby retaining the piston 14 in a first axial position along centreline C_{L} wherein it is outside or externally of the spring sleeve 20 and is in an upper position in which the seal rings 28 are in fluid tight engagement with the housing bore section 12-1.1 thereby providing a fluid tight seal between the high pressure inlet 22 and the fluid outlets 24. In this non-activated condition the fusible sleeve 18 is in its solid state preventing radial outward expansion of the spring sleeve 20.

In case the relief valve 10 is exposed to an abnormally high temperature the fusible sleeve 18 melts and the molten material is expulsed from within the housing longitudinal bore 22 by the expanding spring sleeve 20 through the narrow axial slots 12-3 by the combined action of the spring force of the sleeve and the gas pressure applied to the piston. In the radially outwardly expanded condition of the spring sleeve 20 its inner diameter is larger than (or at least as large as) the outer diameter of the spherical member 16. Accordingly, the spring sleeve 20 is radially outwardly retracted from the path of movement of the spherical member 16 and can no longer act as an axial stop means for the spherical member 20 so that the spherical member 16 can move into the sleeve 20 and is indeed positively moved thereinto by the fluid pressure force applied to the piston 14 and from the piston 14 to the spherical member 16 until the spherical member 16 contacts the inner surface of the housing bottom wall 12-2. The piston 14 is now in a second axial position relative to the centreline C_{L} wherein the stem portion 14-2 extends into the spring sleeve 20 and the radial shoulder surface 14-3 comes to rest on the upper end surface of spring sleeve 20. Further, the piston head portion 14-1 is now positioned entirely within the enlarged diameter portion 12-1.3 of longitudinal bore 12-1 and the high pressure inlet port 22 of housing 12 is in fluid communication with the outlet ports 24. It is noted that the stem portion 14-2 of piston 14 is slightly smaller in diameter than the spherical member or wall member 16 to permit piston stem portion 14-2 to move into the slotted sleeve with minimum frictional resistance.

In use, the relief valve 10 is fixed to a gas tap of a pressurized or liquefied gas cylinder and serves to relief the gas pressure from within the cylinder in the activated condition of FIG. 3 when the gas cylinder and accordingly the relief valve is exposed to an abnormally high temperature, for example in case of a fire.

In another embodiment, shown in FIGS. 5A and 5B, the spherical or ball member 16 forming the abutment member in the embodiment of FIGS. 1-4, is replaced by a lower enlarged diameter abutment end portion 16′ of semi-spherical shape integrally formed with the stem portion 14-2′ of piston 14′. Instead of being semi-spherical this enlarged diameter abutment end portion 16′ may also have a tapered, conical, truncated or curved abutment surface of another appropriate shape for the application of a force to the spring sleeve 20′ to expand the spring sleeve 20′ under the effect of the fluid pressure force applied to the piston 14′. Otherwise, the relief valve of FIGS. 5A and 5B is generally the same as the relief valve of the embodiment of FIGS. 1-4, except that the bore 20-1′ has a generally constant diameter along the length thereof (except at the outlet openings 24′) and the upper sealing ring 28′ is located between two back-up rings 30′ and a split spring retaining ring 32 retains the three rings 28′, 29′, 30′ on the piston 14′.

Further, as shown in FIG. 6, the relief valve housing 112 may be integrally formed in one piece with a body 113 of a tap T, such as a gas tap for a pressurized or liquefied gas container or vessel (not shown). As shown in FIG. 6 the high pressure fluid inlet 122 of the relief valve 110 is in fluid communication with a passage 115 in the tap body 113, which passage 115 opens out in a lower end face 117 of a threaded base section 119 of the tap body 113. When base section 119 is threaded into an opening of a pressurized fluid container or vessel the passage 115 is in fluid communication with the interior of the container or vessel and the relief valve piston 114 is exposed to the fluid pressure in the container or vessel. The relief valve 110 shown in FIG. 6 is generally identical to the relief valve 10 of FIGS. 5A and 5B, except that the housing bore 112-1 opens out in the free end face of the relief valve housing 112 and a plug 124 is threaded into the housing bore 112-1 to close the same and provide an inner abutment surface for the fusible sleeve 118 and the spring sleeve 120. The plug 124 is removable to permit assembly of the pressure relief valve 110 through the free end face of valve housing 112. Also, the fused material outlet slots 12-3 are shorter and do not extend up to the housing end face. Although the relief valve 110 of FIG. 6 has the abutment 116 integrally formed with the piston 114, as in the FIGS. 5A and 5B of the embodiment, the semi-spherical abutment end portion 116 of FIG. 6 may be replaced by a spherical or ball-shaped abutment member separate from the piston 114 as in the embodiment of FIGS. 1-4.

In a further modified embodiment not shown in the drawings the abutment member may be an abutment sleeve separate from the piston and wherein the piston stem is received. This abutment sleeve has at its lower end the abutment surface and may have at its upper end a radial flange for engaging the upper end of the slotted sleeve in the activated condition. In this embodiment the abutment member is not fully received in the slotted spring sleeve in the activated condition of the valve.

Although the invention has been described in considerable detail with reference to preferred embodiment thereof, modifications or variations may be made to the preferred embodiments by one skilled in the art without leaving the scope of the invention as defined by the annexed claims.

1-26. (canceled)

27. A thermally activated pressure relief valve comprising a valve housing having a longitudinal bore, a piston axially movable in the housing bore between a closed position wherein a pressurized fluid is contained in a pressurized fluid container, and an open position in which fluid is vented from the container, and a fusible member effective to normally retain the piston in the closed position; said piston being movable under the pressurized fluid to the open position when the relief valve is exposed to an abnormally high temperature sufficient to cause melting of the fusible means;
wherein the fusible member comprises a fusible sleeve disposed within said housing bore; and said valve further including a slotted spring sleeve disposed within said fusible sleeve and normally maintained by said fusible sleeve in a radially compressed condition wherein the slotted spring sleeve has a smaller inner diameter, said slotted spring sleeve being adapted to expand radially to a radially expanded condition of a larger inner diameter when the relief valve is exposed to said abnormally high temperature causing melting of said fusible sleeve; said spring sleeve when in its said compressed condition being effective to retain said piston in said closed position and said spring sleeve allowing movement of said piston to the open position when in its expanded condition.

28. The relief valve according to claim 27, further comprising an abutment member; said spring sleeve, when in its radially compressed condition, serving as a stop means for said abutment member to prevent movement of the abutment member in the piston opening direction beyond an axial position corresponding to the closed position of the piston; while in the radially expanded condition the spring sleeve allows the abutment member to move relative to the spring sleeve in the piston opening direction beyond said axial position to permit movement of the piston from the closed position to the open position.

29. The relief valve according to claim 28, wherein the housing bore has an axial centerline and the piston, the abutment member and the fusible and spring sleeves are coaxial with said centerline.

30. The relief valve according to claim 28, wherein the abutment member has an abutment surface adapted to axially engage the spring sleeve in the radially compressed condition thereof, said abutment surface decreasing in outer diameter in the direction of movement of the piston from the closed to the open position, said outer diameter of said abutment member being at most as large as the larger inner diameter of the spring sleeve but larger than the smaller inner diameter of the spring sleeve.

31. The relief valve according to claim 28, wherein the abutment member is separate from said piston.

32. The relief valve according to claim 31, wherein said abutment member is a spherical member.

33. The relief valve according to claim 32, wherein a conical recess is provided in an end of said piston facing said spherical member, said conical recess defining a seat surface for said spherical member.

34. The relief valve according to claim 28, wherein the piston has a stem portion and an enlarged head portion, said abutment member and at least a part of said stem portion being received within the spring sleeve when the spring sleeve is in its expanded condition and when said piston is in said open position.

35. The relief valve according to claim 34, wherein said stem portion has a smaller outer diameter than the outer diameter of said abutment member.

36. The relief valve according to claim 27, wherein said piston has an abutment end portion, said spring sleeve, when in its radially compressed condition, serving as a stop means for said abutment end portion to prevent axial movement of the piston from the closed position to the open position; and, while in its radially expanded condition the spring sleeve allows axial movement of the piston from the closed position to the open position.

37. The relief valve according to claim 36, wherein the housing bore has an axial centerline and the piston, the fusible sleeve and the spring sleeve are coaxial of said centerline.

38. The relief valve according to claim 36, wherein the abutment end portion of the piston has an abutment surface adapted to axially engage the spring sleeve in the radially compressed condition thereof, said abutment surface decreasing in outer diameter in the direction of movement of the piston from the closed to the open position, said outer diameter being at most as large as the larger inner diameter of the spring sleeve but larger than the smaller inner diameter of the spring sleeve.

39. The relief valve according to claim 38, wherein the abutment end portion of the piston is semispherical.

40. The relief valve according to claim 36, wherein the piston has a stem portion and an enlarged head portion, said abutment end portion forming an end of the stem portion spaced from the enlarged head portion, at least a part of the stem portion provided with said abutment end portion being received within the spring sleeve in the expanded condition thereof when said piston is in said open position.

41. The relief valve according to claim 40, wherein said stem portion has between the enlarged end portion and the abutment end portion an outer diameter which is smaller than the maximum outer diameter of the abutment end portion.

42. The relief valve according to claim 27, wherein the piston has a radial shoulder surface engaging the spring sleeve when the piston is in said open position.

43. The relief valve according to claim 27, wherein an axial end of each of the fusible sleeve and the spring sleeve faces away from said piston and is in engagement with a radial housing bore surface.

44. The relief valve according to claim 27, wherein said housing has outlet means communicating with the housing bore at the location of the fusible sleeve to permit fused material of said fusible sleeve to flow out from within said housing bore through said outlet means.

45. The relief valve according to claim 44, wherein the outlet means comprises a plurality of circumferentially spaced, axially extending slots formed through a housing wall, said slots extending axially generally along the fusible sleeve.

46. The relief valve according to claim 45, wherein the axially extending slots have a relatively narrow width in circumferential direction to resist flowage of the fusible sleeve into said slots in its solid, non-fused condition.

47. The relief valve according to claim 27, wherein said fusible sleeve consists of a eutectic material.

48. The relief valve according to claim 27, wherein the spring sleeve is of metallic, preferably spring steel material.

49. The relief valve according to claim 27, wherein the spring sleeve is axially slotted.

50. The relief valve according to claim 27, wherein the housing has an outer screw thread on an end portion thereof for threadably screwing the relief valve in an opening of a tap body, such as a pressurized or liquefied gas tap body.

51. The relief valve according to claim 50, wherein an annular sealing cap is provided on said housing end portion.

52. The relief valve according to claim 27, wherein the valve housing has a fluid inlet and a fluid outlet and in the closed position the piston seals off fluid communication between the inlet and the outlet, said piston placing the inlet and outlet in fluid communication with one another when in the open position.

53. A tap for a pressurized or liquefied gas cylinder, comprising a tap body having a flow passage opening out in a base portion of the tap body for communication with a pressurized fluid container to which the tap is to be mounted, and a thermally activated pressure relief valve having a piston movable in a tap body bore between a closed position wherein it seals off fluid communication between said flow passage and a vent opening and an open position wherein the flow passage and the vent opening are in fluid communication; said pressure relief valve further having a fusible member effective to normally retain the piston in the closed position, said piston being movable by the high pressure fluid to the open position in case of exposure of said tap to an abnormally high temperature sufficient to cause melting of said fusible member,
wherein said fusible member is a fusible sleeve disposed within said tap body bore; a slotted spring sleeve being disposed within said fusible sleeve and normally maintained by said fusible sleeve in a radially compressed condition wherein the slotted spring sleeve has a smaller inner diameter; said slotted sleeve being adapted to expand radially to a radially expanded condition of larger inner diameter when said tap is exposed to said abnormally high temperature causing melting of said fusible sleeve; said spring sleeve when in said compressed condition being effective to retain said piston in said closed position and said spring sleeve allowing movement of said piston to the open position when in its expanded condition.

54. The tap according to claim 53, wherein a removable plug is secured to said tap body to close an outer end of said tap body bore and provide an abutment for said fusible and spring sleeves and permit insertion of said piston and said sleeves into said tap body bore prior to installation of said plug.
